(19) United States
(12) Patent Application Publication
(10) Pub. No.: US 2013/0343607 A1
(43) Pub. Date: Dec. 26, 2013

(54) METHOD FOR TOUCHLESS CONTROL OF A DEVICE

(71) Applicant: POINTGRAB LTD., Hod Hasharon (IL)

(72) Inventors: Saar WILF, Tel Aviv (IL); Haim Perski, Hod-HaSharon (IL)

(21) Appl. No.: 13/907,925

(22) Filed: Jun. 2, 2013

Related U.S. Application Data
(60) Provisional application No. 61/662,046, filed on Jun. 20, 2012.

(51) Int. Cl. G06F 3/01

(52) U.S. Cl. CPC G06F 3/017
USPC 382/103

(57) ABSTRACT

A system and method for computer vision based control of a device may include using a virtual line passing through an area of a user's eyes and through a user's hand (or any object controlled by the user) to a display of the device, to control the device.

### PRIOR APPLICATION DATA

The present application claims benefit from U.S. Provisional application No. 61/662,046, incorporated by reference herein in its entirety.

### FIELD OF THE INVENTION

The present invention relates to the field of machine-user interaction. Specifically, the invention relates to user control of electronic devices having a display.

### BACKGROUND OF THE INVENTION

The need for more convenient, intuitive and portable input devices increases, as computers and other electronic devices become more prevalent in our everyday life.

Recently, human gesturing, such as hand gesturing, has been suggested as a user interface input tool in which a hand gesture is detected by a camera and is translated into a specific command. Gesture recognition enables humans to interface with machines naturally without any additional mechanical appliances such as mice or keyboards. Additionally, gesture recognition enables operating devices from a distance; the user need not touch a keyboard or a touchscreen in order to control the device.

In some systems, when operating a device having a display, once a user's hand is identified, an icon appears on the display to symbolize the user's hand and movement of the user's hand is translated to movement of the icon on the device. The user may move his hand to bring the icon to a desired location on the display to interact with the display at that location (e.g., to emulate mouse right or left click by hand posturing or gesturing). This type of interaction with a display involves coordination skills which may be lacking in some users (e.g., small children lack this dexterity) and is typically slower and less intuitive than directly interacting with a display, for example, when using a touch screen.

Virtual touch screens are described where a user may interact directly with displayed content. These virtual touch screens include a user interface system that displays images “in the air” by using a rear projector system to create images that look three dimensional and appear to float in midair. A user may then interact with these floating images by using hand gestures or postures. These systems, which require special equipment, are typically expensive and not easily mobile.

### SUMMARY OF THE INVENTION

A method for machine-user interaction, according to embodiments of the invention, may provide an easily mobile and straightforward solution for direct, touchless interaction with displayed content.

According to embodiments of the invention a user may interact with a display of a device by simply directing his arm or finger at a desired location on the display, without having to touch the display, and the system is able to translate the direction of the user's pointing to the actual desired location on the display and cause an interaction with the display at the location pointed at. This enables easy direct interaction with the display as opposed to the current touchless interactions with displays in which a user must first interact with a cursor on a display and then move the cursor to a desired location on the display.

In another embodiment methods of the invention may be used to interact with devices not necessarily by interacting with a display of the device.

### BRIEF DESCRIPTION OF THE FIGURES

The invention will now be described in relation to certain examples and embodiments with reference to the following illustrative figures so that it may be more fully understood. In the drawings:

FIGS. 1A-D schematically illustrate a system and methods for controlling a device according to embodiments of the invention;

FIG. 2 schematically illustrates a method for controlling a device according to another embodiment of the invention;

FIG. 3 schematically illustrates a method for controlling a device by calibration according to another embodiment of the invention; and

FIG. 4 schematically illustrates a method for controlling a device by detecting an intersection point of a user's pointing arm with the display, according to an embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may provide methods for controlling a device (e.g., a television, cable television box, personal computer or other computer, video gaming system, etc.) by natural and constraint-free interaction with a display (e.g., a monitor, LCD or other screen, television, etc.) of the device or with a user interface displayed by the device (e.g. on the display or monitor or on an external surface onto which content is projected by the device). Methods according to embodiments of the invention may translate the location of a user's hand in space to absolute display coordinates thus enabling direct interaction with the display or with displayed objects with no special effort required from the user.

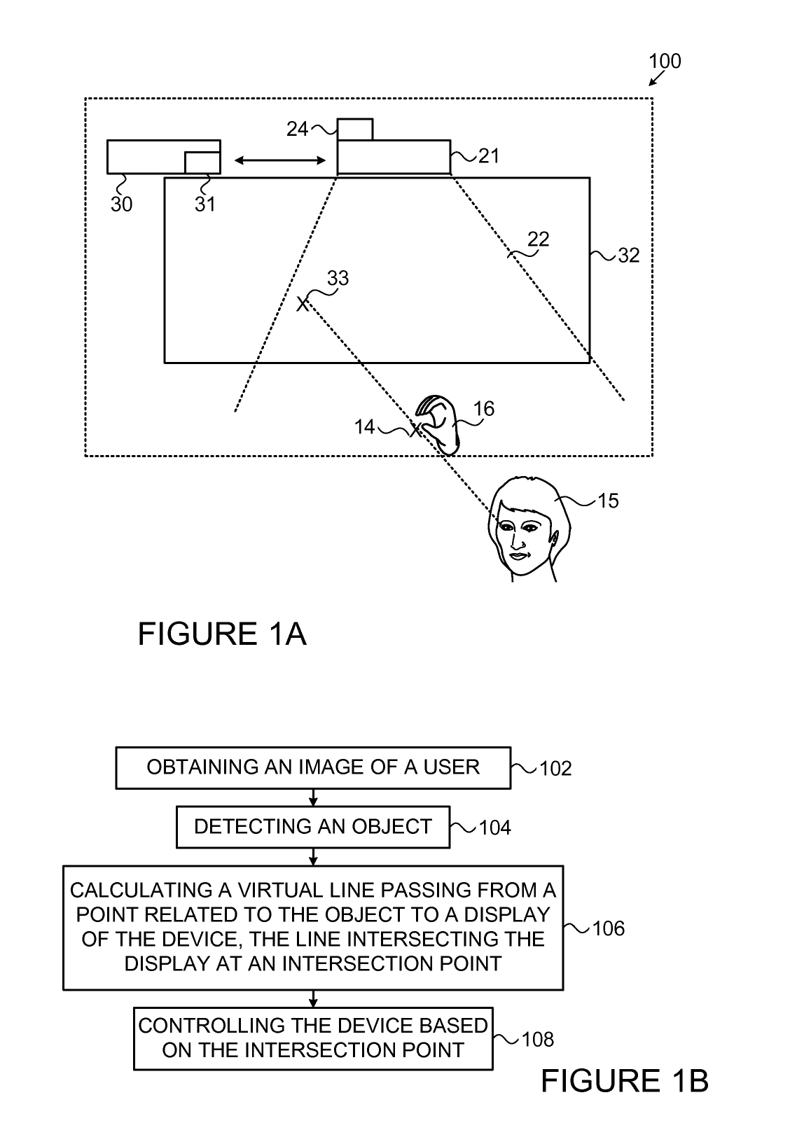

Methods according to embodiments of the invention may be implemented in a user-device interaction system, such as the system 100 schematically illustrated in FIG. 1A, which includes a device 30 to be operated and controlled by user commands, typically by touchlessly interacting with a display 32 of the device (e.g., a monitor, a touchscreen, etc.), and an image sensor (e.g., a digital camera 21 or imager). According to embodiments of the invention user commands may be based on identification and tracking of the user's hand. The system 100 identifies the user's hand in the images captured or obtained by the image sensor, such as camera 21. Once a user's hand 16 is identified it may be tracked such that movement of the hand may be followed and translated into operating and control commands. For example, the device may include a display 32 and movement of a hand may be translated into movement on the display of an icon or symbol, such as a cursor or any other displayed object, or another manipulation of content on the display.

The image sensor may be a standard two-dimensional (2D) camera and may be associated with a processor 31 associated with one or more storage device(s) 24 for storing image data. A storage device 24 may be integrated within the image sensor and/or processor 31 or may be external to the image sensor and/or processor 31. According to some embodiments image data may be stored in the processor 31 (or other processor), for example in a storage device 24. In some embodiments image data of a field of view (which includes a user's hand) is sent to the processor 31 for analysis. A user command is generated by the processor 31 or by another processor such as a controller, based on the image analysis, and is sent to the device 30, which may be any electronic device that can accept user commands from the controller, e.g., television (TV), DVD player, personal computer (PC), mobile telephone, camera, STB (Set Top Box), streamer, etc.

Processor 31, may include, for example, a central processing unit (CPU), a digital signal processor (DSP), a microprocessor, a controller, a chip, a microchip, an integrated circuit (IC), cache memory, or any other suitable multi-purpose or specific processor or controller, and may be one or more processor. Storage device 24, may include, for example, a random access memory (RAM), a dynamic RAM (DRAM), a flash memory, a volatile memory, a non-volatile memory, a cache memory, a buffer, a short term memory unit, a long term memory unit (e.g. disk drive), or other suitable memory units or storage units.

According to one embodiment the device 30 is an electronic device available with an integrated standard 2D camera. According to other embodiments a camera is an external accessory to the device, typically positioned at a known position relative to the display of the device. According to some embodiments more than one 2D camera is provided to enable capturing or obtaining three dimensional (3D) information. According to some embodiments the system includes a 3D camera, such as a range camera using time-of-flight or other methods for obtaining distance of imaged objects from the camera.

One or more detectors may be used for correct identification of a moving object and for identification of different postures (e.g., shapes produced by a user's hand or positioning parts of a hand) of a hand. For example, a contour detector may be used together with a feature detector.

Methods for tracking a user's hand may include using an optical flow algorithm or other known tracking methods. These algorithms and detectors, and other aspects of the invention, may be implemented in software, for example executed by processor 31 and/or other processors (not shown).

While operating a device according to embodiments of the invention a user is sometimes positioned in front of a camera and a display, for example, as schematically illustrated, in FIG. 1A. The user 15 (or any part of the user) is located within the field of view 22 of the camera 21. The user 15 controls an object (for example, the object may be the user's hand 16) to control a device 30. According to one embodiment the user 15 uses his hand 16 to gesture or holds his hand in a specific posture which is detected by the camera 21 and is recognized by image processing algorithms executed by or running on a processor 31, which is typically in communication with the device 30.

The user 15 typically interacts with a display 32, which may be connected to the device 30 (or which may be displayed by the device, such as content projected by device 30), to control the device 30, for example, by emulating a mouse click on the icons on the display 32 to open files or applications of device 30, to control volume or other parameters of a running program or to manipulate content on the display 32 (such as zoom-in, drag, rotate etc.). Other commands may be given, for example to control a game, control a television, etc.

In order to interact with the display 32 at a specific desired location, e.g., at icon 33, the user 15 typically brings his hand 16 into his line of sight together with the icon 33 on the display, such that from the user's point of view, the hand 16 (or any object held by the user or any part of the hand, such as a finger) is covering, partially covering or covering an area in the vicinity of the icon 33. The user 15 may then gesture or hold his hand in a specific predetermined posture to emulate a mouse click or to otherwise interact with the display 32 at the location of the icon 33.

For example, icons on a display may include keys of a virtual keyboard and the user may select each key by essentially directing his hand at each key and posturing or providing a movement to select the key and to write text on the display.

In this way the user directly interacts with the display 32 at desired locations in a way that is more natural and intuitive to the user than current hand gesturing systems.

According to another embodiment the user 15 may control the device 30 by bringing his hand 16 into his line of sight together with any point in a pre-defined area (e.g., on a display or on any other area associated with the device). The user 15 may be pointing or otherwise directing his hand 16 at a predefined point (typically a point associated with the device) or any point that falls within the predefined area. From the user's point of view, the hand 16 (or any object held by the user or any part of the hand, such as a finger) should be covering, partially covering or in the vicinity of a predetermined point or within a pre-determined area. The user 15 may then gesture or hold his hand in a specific predetermined posture to interact with the device 30.

For example, a user may point a finger at a TV or other electrical appliance (which does not necessarily have a display) such as an air-conditioner, to turn on or off the appliance based on the specific posture directed at the appliance.

Methods according to embodiments of the invention are used in order to enable “translation” of the user's activities to correct operation of the device.

A method for computer vision based control of a device, according to one embodiment of the invention, is schematically illustrated in FIG. 1B. The method includes obtaining an image of a user (102) (it should be appreciated that “obtaining an image of a user” includes capturing or obtaining an image of any part of a user and/or obtaining a full image of the user and may relate to 2D and/or 3D images). Typically an imager (e.g., a camera) obtains an image of a field of view which includes a user, or a portion of a user. An object controlled by the user is then detected (104) by using computer vision techniques, for example by applying shape recognition algorithms on the image or by using other object detection techniques (which may include color detection and other appropriate computer vision techniques). The object is typically an object that is controlled by the user's hand, such as a stylus or other object held in the user's hand. The object may be the user's hand (or other body part) itself or any part of the user's hand (or other body part).

The method further includes defining, calculating or determining a virtual line (e.g., determining the three dimensional coordinates of the line) passing through a point related to the object and intersecting a display of the device (106). The device is then controlled based on the intersection point (108).

According to one embodiment the method includes calculating or determining a virtual line passing through a point related to the object and intersecting a predefined area (optionally an area associated with the device, such as the area of the device itself or an area of a switch related to the device). The device is then controlled based on the intersection point.

The point related to the object may be any point or area on the object or in vicinity of the object. According to one embodiment the point is at the tip of a finger or close to a tip of a finger, for example, the tip of a finger pointing at a display or in between the tip of the thumb and the tip of another finger when a hand is in a posture where the thumb is touching or almost touching another finger so as to create an enclosed space, for example, point 14 in FIG. 1A.

It should be appreciated that the intersection point with the display (or other pre-defined area) is essentially the location on the display or other pre-defined area at which the user is aiming when operating the device as described with reference to FIG. 1A.

According to one embodiment, an indication (e.g., a graphical or other indication) of the intersection point is displayed on the display, typically at the location of the intersection point on the display, so as to give the user an indication of where he is interacting with the display.

According to one embodiment, the virtual line is dependent on the location of a user's head or more specifically, on an area of the user's head or face, possibly location or an area of the user's eyes, e.g., the area(s) in the image in which the user's eyes are detected. According to one embodiment, which is schematically illustrated in FIG. 1C, the method includes obtaining an image of a user (or any part of a user) (112); detecting an object controlled by the user (114) and finding detecting an area of the user's eyes (116) (e.g., determining which portion of a captured image includes the user's eye(s)). A virtual line is then calculated from a point in the area or a point from the location of the user's eyes passing through a point related to the object to an intersection point with a display (or other pre-defined area) of the device (118). The device is then controlled based on the intersection point (119).

According to one embodiment, which is schematically illustrated in FIG. 1D, the method includes capturing or obtaining an image of a field of view which includes a user (120) and detecting or determining within the image an area of the user's face and also detecting the user's hand (at least a part of the user's hand) (122). E.g., which portion of the image includes the face and all or part of the hands, may be determined. A point (e.g., a pixel, set of pixels, a coordinate represented as, for example, an X, Y coordinate, etc.) on the display (or other pre-defined area) is then detected (123), the point being on a virtual line, the virtual line being dependent on the location of the user's face and the location of the user's hand. A device may then be controlled based on the point on the display (124) or other pre-defined area.

Calculating the virtual line or the point on the display (or other pre-defined area) which is related to the virtual line, may be done, for example, by determining the x,y,z coordinates of the point related to the object (e.g., point 14 in FIG. 1A, which may be determined, for example, by detecting an outline of the object or a geometric shape (e.g., a rectangle) enclosing the object and using an estimated location of the point within the outline or geometric shape) and of the point in the area of the user's face (e.g., a point related to the user's eyes). The origin of the x, y, z coordinates may be at the location of the camera or at any other suitable location. Information obtained from the camera may be used to determine the angle of view to the area of the user's face (e.g., eyes) and to the point related to the object. The distance of the camera from either point may be also determined (e.g., using 3D or stereoscopic information or other information, such as size of imaged objects, as further discussed below). Using the distance and angle the x,y,z coordinates of each point may be determined and then used to calculate a virtual line passing through both points (point in user's face and point related to the object) and through the display (or other pre-defined area).

According to one embodiment the method includes first detecting the user's face (for example, by using known face detectors, which typically use object-class detectors to identify facial features). The eyes, or the area of the eyes, may then be detected within the face. According to some embodiments an eye detector may be used to detect at least one of the user's eyes. Eye detection using OpenCV's boosted cascade of Haar-like features may be applied. Other methods may be used. The method may further include tracking at least one of the user's eyes (e.g., by using known eye trackers).

According to one embodiment the user's dominant eye is detected, or the location in the image of the dominant eye is detected, and is used to determine the virtual line. Eye dominance (also known as ocular dominance) is the tendency to prefer visual input from one eye to the other. In normal human vision there is an effect of parallax, and therefore the dominant eye is the one that is primarily relied on for precise positional information. Thus, detecting the user's dominant eye and using the dominant eye as a reference point for the virtual line, may assist in more accurate control of a device.

In other embodiments detecting the area of the use's eye may include detecting a point in between both eyes or any other point related to the eyes. According to some embodiments one of the eyes may be detected. According to one embodiment a user may select which eye (left or right) should be detected by the system.

According to one embodiment detecting an object is done by using shape detection. Detecting a shape of a hand, for example, may be done by applying a shape recognition algorithm, using machine learning techniques and other suitable shape detection methods, and optionally checking additional parameters, such as color parameters.

Detecting a finger may be done, for example, by segmenting and separately identifying the area of the base of a hand (hand without fingers) and the area of the fingers, e.g. the area of each finger. Separately identifying the hand area and the finger areas provides means for selectively defining tracking points that are either associated with hand motion, finger motion and/or a desired combination of hand and one or more finger motions. According to one embodiment four local minimum points in a direction generally perpendicular to a longitudinal axis of the hand are sought. The local minimum points typically correspond to connecting area between the fingers, e.g. the base of the fingers. The local minimum points may define a segment and a tracking point of a finger may be selected as a point most distal from the segment.

According to one embodiment movement of a finger along the Z axis relative to the camera may be defined as a “select” gesture. Movement along the Z axis may be detected by detecting a pitch angle of a finger (or other body part or object), by detecting a change of size or shape of the finger or other object, by detecting a transformation of movement of selected points/pixels from within images of a hand, determining changes of scale along X and Y axes from the transformations and determining movement along the Z axis from the scale changes or any other appropriate methods, for example, by using stereoscopy or 3D imagers.

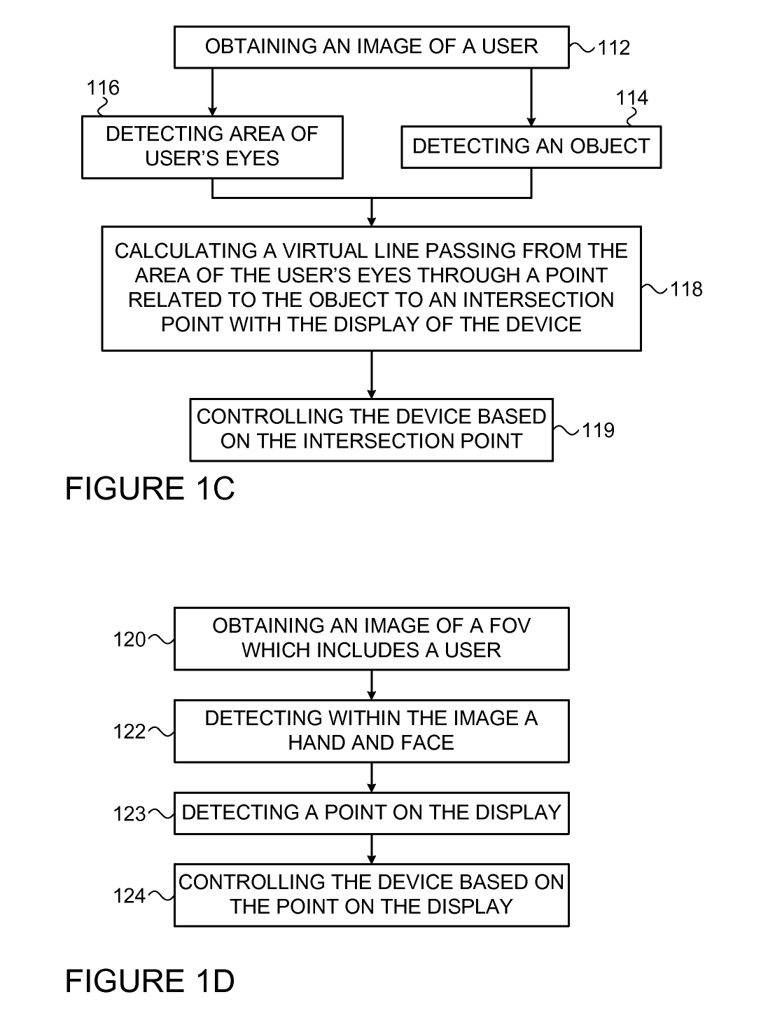

A method for controlling a device by posturing according to an embodiment of the invention is schematically illustrated in FIG. 2. The method includes obtaining an image of a user (or any part of a user) (212); detecting an object controlled by the user (214); detecting the shape of the object (216) and determining a point related to the object (218). An intersection point is calculated using the determined point related to the object (219), for example, as described above, and the device is then controlled based on the intersection point and on the detected shape of the object (220).

Detecting the shape of the object, e.g., the user's hand, typically by using shape recognition algorithms, assists in detecting different postures of the user's hand. Interacting with a display may include performing predetermined postures. For example, a mouse click or “select” command may be performed when a user's hand is in a posture or pose where the thumb is touching or almost touching another finger so as to create an enclosed space between them. Another example of a posture for “select” may be a hand with all fingers brought together such that their tips are touching or almost touching. Other postures are possible.

The point related to the object, through which the virtual line is passed, may be any point or area on the object or in vicinity of the object. According to one embodiment the point is at the tip of a finger or close to a tip of a finger, for example in between the tip of the thumb and the tip of another finger when a hand is in a posture where the thumb is or almost touching another finger so as to create an enclosed space.

Once a specific posture or gesture of the hand is detected a user command is generated and may be received by the device or a module of the device, thus allowing the user to interact with the device. For example, based on the interpretation of a line, the object being pointed to, and possibly other information such as a gesture or posture, a command or other input information may be generated and used by the device.

For example, when a user directs a finger or hand in which the thumb is almost touching another finger so as to create an enclosed space, at a specific location or icon on a display or at another pre-defined area related to a device, a point at the tip or near the tip of the finger, or in between the thumb and other finger is detected and an intersection point on the display (or pre-defined area) is calculated. When the user postures or gestures, such as moves his finger, or postures, such as connects the thumb and other finger to create a round shape with his fingers, a command, such as turn ON/OFF or “select”, is generated or applied, possibly, at or pertaining to the location of the calculated intersection point.

According to one embodiment the device may be controlled based on the intersection point and based on movement of the object (e.g. hand). Displayed content may be controlled. For example, the user may move his hand (after performing a predetermined posture or gesture) or any object held by his hand, to drag or otherwise manipulate content in the vicinity of the intersection point.

According to one embodiment an intersection point may be calculated by determining a distance of the part of the user's hand or of the user's face from the camera used to obtain the image of the field of view and then using the distance of the part of the hand or of the user's face from the camera to calculate the point on the display.

The distance of the part of the user's hand or of the user's face from the camera may be determined by determining a size of the part of the user's hand or of the user's face, for example, as described herein. Thus, the size of the part of the user's hand and/or of the user's face may be used to calculate the point on the display.

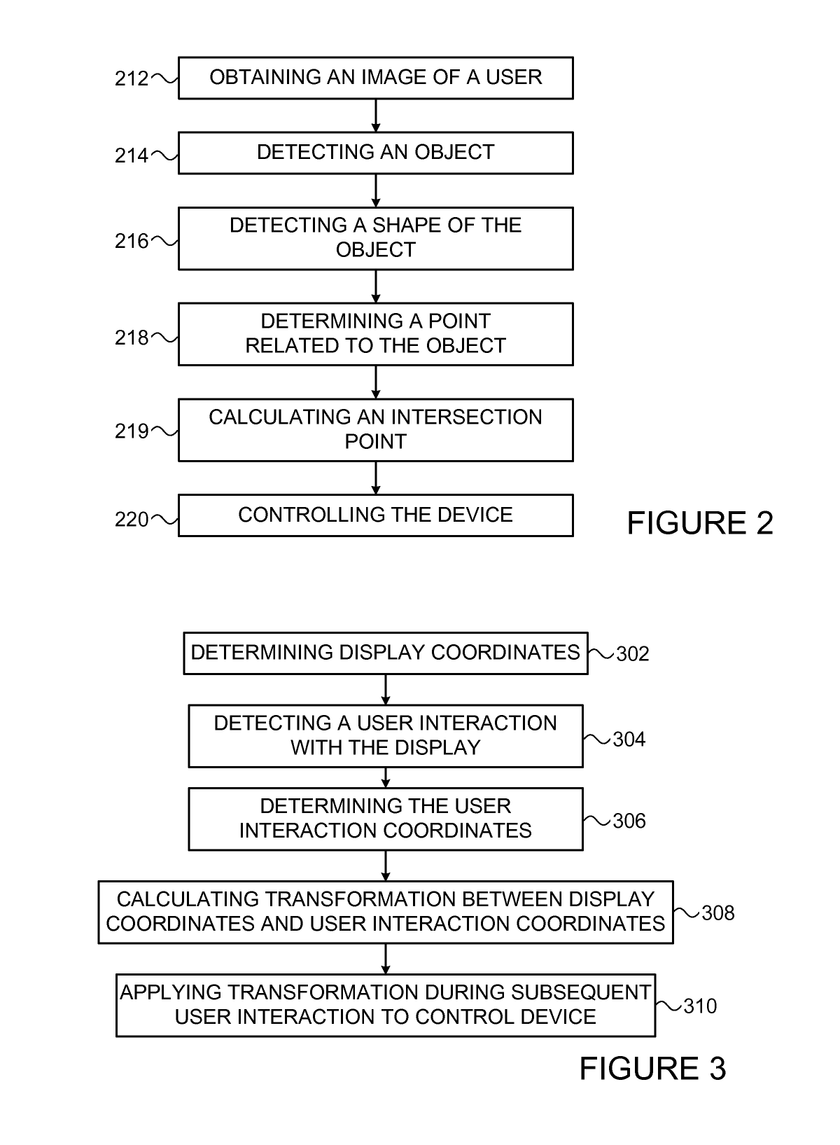

According to another embodiment an intersection point may be calculated based on a calibration process, for example, as schematically illustrated in FIG. 3. This process enables direct touchless interaction with a display using a standard 2D camera, without requiring a stereoscopic or 3D camera.

One embodiment includes determining a first set of display coordinates (302); detecting a predefined user interaction with a display (304); determining a second set of coordinates which correlate to the detected user interaction (306); calculating a transformation between the first set of coordinates to the second set of coordinates (308); and applying the calculated transformation during a subsequent user interaction to control the device (310).

According to one embodiment the distance from the camera to a point related to an object controlled by the user (e.g., the user's hand or part of hand) and/or to the area of the user's eyes may be estimated or calculated through a calibration process. According to one embodiment a user is required to position his hand and/or face at a predetermined distance from the camera. For example, the user may be required to initially align his hand with the end of the keyboard of a laptop computer (the distance between a 2D camera embedded in the laptop and the end of the keyboard being a known distance). The user may then be required to align his hand with his face (the distance between the end of the keyboard and the user's face being estimated/known). The size of the user's hand may be determined in the initial position (aligned with the end of the keyboard) and in the second position (aligned with the user's face). Each of the measured sizes of the user's hand during calibration can be related to a certain known (or estimated) distance from the camera, thus enabling to calculate the distance from the camera for future measured sizes of the user's hand.

A first known point on a virtual line passing through a point related to an object (e.g. the user's hand) and the display is the interaction point with the display (the first set of display coordinates). Two other points on the virtual line are the x,y, z coordinates of the point related to the object and the area of the user's eyes (determined, for example, by using the calibration process as described above). A virtual line can thus be calculated for each location of the user's hand using a 2D camera.

The sizes of the user's face and hand may be saved in the system and used to calculate a virtual line in subsequent uses of the same user.

According to the embodiment described in FIG. 3 a user may be required to interact with a display at a first set of display coordinates which are at defined locations (e.g., to posture while directing at specific icons provided by the system) or in a defined sequence (e.g., posture or gesture at a first icon, then posture at a second icon). The location in space of the user's hand (or other object) while interacting with the system-defined display coordinates can be used to calibrate the system for each user. Calibration may be done by calculating the transformation between the system-defined locations on the display and the locations of the user interactions in space. The calculated transformation may be applied to subsequent user interactions such that subsequent user interactions may be accurately translated to locations on the display.

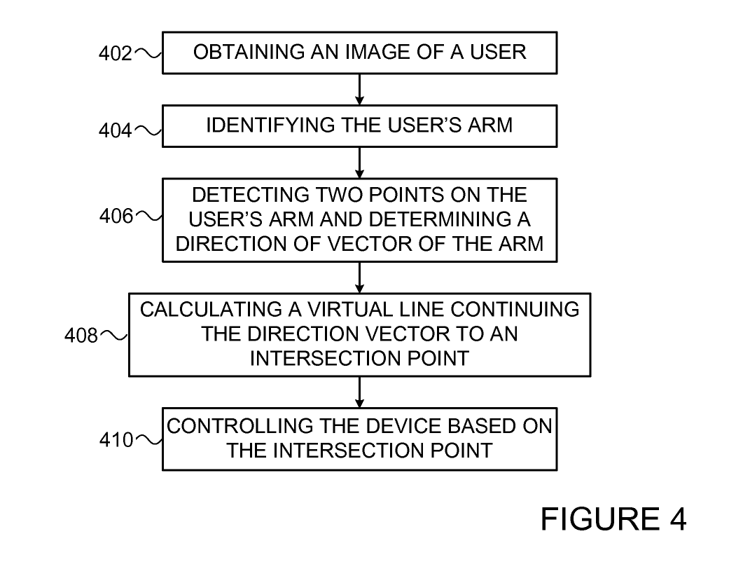

According to another embodiment a user may control a device by pointing or directing an arm at desired locations on a display of the device. An intersection point may be calculated by detecting the user's arm (typically the arm directed at the device's display) and continuing a virtual line from the user's arm to the display or other pre-defined area or location, as schematically illustrated in FIG. 4.

An embodiment of a method for computer vision based control of a device having a display may include the operations of obtaining an image of a user (or any part of a user) (402), typically of a field of view which includes a user. The user's arm may be then identified (404), for example by using TRS (translation, rotation, and scaling)-invariant probabilistic human body models. Two points on the user's arm may be determined and a direction vector of the user's arm may be calculated using the two determined points (406). A virtual line continuing the direction vector and intersecting the display (or other pre-defined area) of the device is calculated (408) thereby calculating the intersection point. The device can then be controlled based on the intersection point (410), for example, as described above.

This embodiment which includes continuing a direction vector of an arm pointing at a display may be applied to other body parts pointed at a display. For example, the method may include detecting a direction vector of a user's finger and finding the intersection point of the user's finger with the display, such that a device may be controlled by pointing and movement of a user's finger rather than the user's arm.

Embodiments of the invention may include an article such as a computer processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for computer vision based control of a device, the device in communication with a display, the method comprising
obtaining an image of a field of view, the field of view comprising a user;
detecting within the image an area of the user's face and at least a part of the user's hand;
detecting a point on the display, the point being on a virtual line which is dependent on a location of the user's face and on a location of the part of the user's hand; and
controlling the device based on the point on the display.

2. The method of claim 1 comprising detecting an area of the user's eyes and wherein the virtual line is dependent on the location of the area of the user's eyes.

3. The method of claim 1 comprising detecting a dominant eye of the user and wherein the virtual line is dependent on the location of the dominant eye of the user.

4. The method of claim 1 wherein detecting at least a part of the user's hand comprises detecting a shape of the of the user's hand or part of the user's hand and further comprising controlling the device based on the point on the display and based on the shape of the user's hand or part of the user's hand.

5. The method of claim 4 comprising controlling the device based on the point on the display and based on a movement of the user's hand or part of the user's hand.

6. The method of claim 1 wherein the location of the user's hand or part of the user's hand comprises a point in between a tip of a thumb and a tip of another finger almost touching the thumb.

7. The method of claim 1 wherein controlling the device comprises controlling content displayed on the display.

8. The method of claim 1 comprising displaying an indication of the point on the display at the location of the point on the display.

9. The method of claim 1 comprising:
determining a distance of the part of the user's hand from a camera used to obtain the image of the field of view; and
using the distance of the part of the hand from the camera to calculate the point on the display.

10. The method of claim 1 comprising
determining a distance of the area of the user's face from a camera used to obtain the image of the field of view; and
using the distance of the area of the user's face from the camera to calculate the point on the display.

11. A method for computer vision based control of a device, the device in communication with a display and a camera, the method comprising
capturing by the camera an image comprising a user;
detecting within the image an area of the user's face and at least a part of the user's hand;
calculating a virtual line passing through the area of the user's face and through the part of the user's hand to the display, the virtual line passing through the display at a point on the display; and
controlling the device based on the point on the display.

12. The method of claim 11 comprising controlling the device based on the point on the display and based on a posture of the part of the user's hand.

13. The method of claim 11 comprising applying shape recognition algorithms to detect at least part of the user's hand.

14. The method of claim 11 wherein controlling the device comprises manipulating content on the display according to movement of the part of the user's hand.

15. The method of claim 11 comprising determining a size of the part of the user's hand or of the user's face and using the size of the part of the user's hand or user's face to calculate the point on the display.

16. The method of claim 11 wherein the camera is a 2D camera.

17. A system for computer vision based control of a device, the system comprising
an imager to obtain an image of a user;
a display in communication with the device;
a processor to:
detect within the image an area of the user's face and at least a user's hand;
calculate a point on the display, the point being on a virtual line which is dependent on a location of the user's face and on a location of the part of the user's hand; and
control the device based on the point on the display.

18. The system of claim 17 wherein the imager is a 2D camera.

19. The system of claim 17 wherein the imager is positioned at a known position relative to the display.

20. The system of claim 17 wherein the processor to detect within the image an area of the user's face and at least a user's hand applies shape recognition algorithms on the image.
